(19) United States
(12) Patent Application Publication
(10) Pub. No.: US 2001/0051376 A1
(43) Pub. Date: Dec. 13, 2001

(54) Apparatus and method for testing samples of a solid material

(76) Inventor: Robert Jan Jonker, Amsterdam (NL)

Correspondence Address: Louis A. Morris, Akzo Nobel Inc., 7 Livingstone Avenue, Dobbs Ferry, NY, 10522-3408, US

(21) Appl. No.: 09/835,888

(22) Filed: Apr. 16, 2001

Related U.S. Application Data
(60) Provisional application No. 60/201,524, filed on May 2, 2000.

(30) Foreign Application Priority Data
Apr. 14, 2000 (EP) 00201340.7

(51) Int. Cl. G01N 31/10

(52) U.S. Cl. 436/37; 422/104; 422/68.1; 436/43

(57) ABSTRACT

The invention pertains to an apparatus for testing samples of a solid material, such as a catalyst or an adsorbent, contained in a reactor tube, said apparatus comprising a holder for a tube and a flow module for generating a carrier fluid flow containing a probe through a tube positioned in the holder. The apparatus further comprises a magazine for tubes or means for accommodating a magazine for tubes, and means for replacing a tube positioned in the holder with a tube from the magazine.

### CROSS REFERENCE TO RELATED APPLICATIONS

This application is based on European Patent Application No. 00201340.7, filed Apr. 14, 2000 and U.S. Provisional Patent Application No. 60/201524, filed May 2, 2000.

### BACKGROUND OF THE INVENTION

1. Field of the Invention

The invention pertains to an apparatus for testing samples of a solid material, such as a catalyst or an adsorbent, contained in a reactor tube, said apparatus at least comprising a holder for a tube, a flow module for generating a carrier fluid flow containing a probe through a tube positioned in the holder.

2. Prior Art

Apparatuses are generally known and used in the testing of catalyst samples, for example to locate the performance optima of a particular catalyst in very complicated and large parameter spaces or to select the most suitable catalyst for a particular process from a number of candidates. Also, operation windows can be accurately mapped and certain process variables are more readily understood, which may result in more robust manufacturing recipes.

The more advanced methods of analysis involve, for instance, measuring the pulse Response of a catalyst sample contained in an experimentation reactor, such as a thermostatic glass or quartz tube. A substantially constant flow of a gaseous or liquid carrier fluid is led through the catalyst sample. The catalyst sample can be present, e.g., in the form of a fixed bed or a bed that is fluidized by the carrier fluid. A probe, such as an accurately defined amount of hydrogen or of a particular organic compound or a particular composition of organic compounds, is injected into the flow of carrier fluid during a well-defined (usually very narrow) time-span, thus effectively creating a pulse.

In another method of analysis, the catalyst contained in a reactor tube is continuously being perfused with a probe, while the temperature is, e.g., accurately maintained, decreased or increased during a linear temperature program. The response of the catalyst, i.e. the composition of the reaction products and the distribution in time of the composition, is determined in an analysis system. Various performance parameters of the catalyst, such as conversion, chemical states of the active sites, selectivity, and metal dispersion can be derived from this response.

By carrying out a very substantial number of these kinds of experiments, it is possible, among other things, to locate the said performance optima or to accurately map the said operation windows. As a matter of course, substantial experimentation requires substantial labor, time and expenses.

In the petrochemical catalyst industry, a strong need exists for high-throughput experimentation techniques for (combinatorial) catalysis.

It is an object of the invention to provide an improved apparatus for analyzing samples of solid materials that allows acceleration of the design and hence shortens the time to market of a new catalyst.

### SUMMARY OF THE INVENTION

1. Accordingly, in one embodiment, the invention comprises an apparatus for testing samples of a solid material contained in a reactor tube, the apparatus comprising a holder for the tube, a flow module for generating a carrier fluid flow containing a probe accordingly, allows a very substantial reduction of the time and effort that are required, e.g., to develop a new catalyst.

Further, it was found that the object of the invention can also be achieved by combining an existing automated thermal desorption unit and a flow module for generating a carrier fluid flow containing a probe. In such units, it is preferred that the carrier fluid is gaseous (instead of liquid).

Thus, the apparatus according to the present invention can be built using generally known and available components such as the aforementioned automated thermal desorption unit and the aforementioned flow module.

In methods that employ a pulsed or stepped probe, it is preferred that the flow module further comprises an injector for injecting a probe and/or additional carrier fluid into the carrier fluid flow. It is further preferred that the probe and/or additional carrier fluid is injected into the carrier fluid flow relatively close to the holder. Thus, disturbance of the fluid flow in the feedline is substantially avoided.

The flow module preferably comprises a feedline for establishing fluid communication with a tube that is placed into the holder wherein the cross-sectional area of the lumen of the feed line (downstream of the injector) is substantially smaller than the cross-sectional area of the lumen of the tube. Thus, the shape of the pulse inputted into the feed line can be maintained more accurately, and there will be less risk of information obtainable from the pulse response being lost, or such risk may even be substantially avoided.

It is preferred that the temperature of a tube placed in the holder can be accurately controlled. It is further preferred that at least one of the tubes in the magazine is a blank tube, i.e. a tube that does not contain a catalyst sample. Thus, a blank tube sample is automatically inserted before the start of an actual run and sample carryover is substantially avoided. It is preferred that every other tube in the magazine is a blank tube.

The invention may use an automated thermal desorption unit for testing a plurality of samples of a solid material by means a probe.

The invention will be further explained with reference to the drawings, in which an embodiments of the apparatus of the invention is schematically shown.

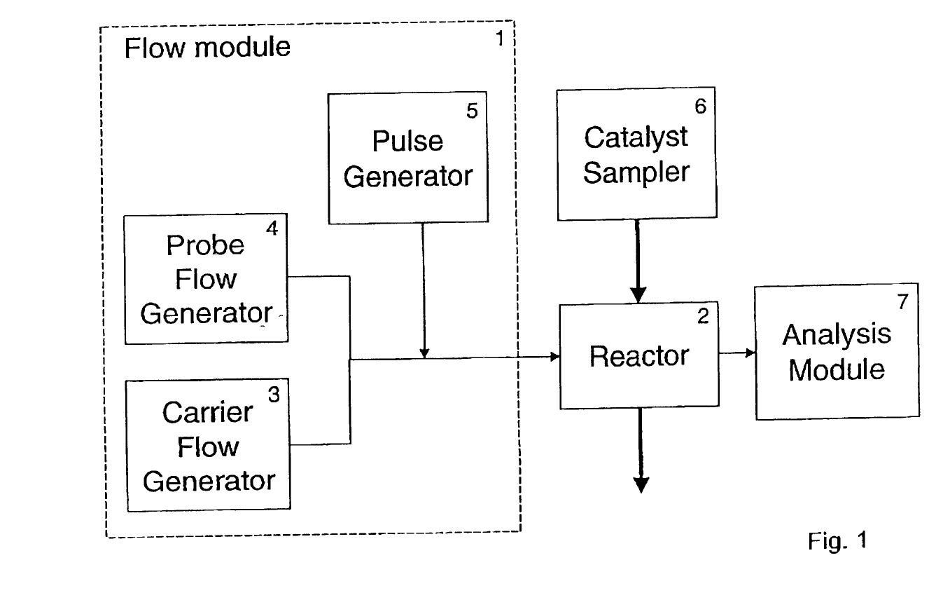

FIG. 1 shows a flow module 1, which is in fluid communication with a reactor 2 containing a sample of a solid material, such as a catalyst, by means of a feed line.

The flow module 1 supplies a carrier fluid flow containing a probe to the reactor 2 and should be capable of operating at constant flows or pressures. The flow module 1 shown in the Figure comprises a carrier fluid flow generator 3, a probe flow generator 4 and a pulse generator 5, which, in this particular example is arranged to generate a pulse of a probe or of additional carrier material. Several input signals are conceivable.

If the probe flow generator 4 is turned off, the fluid flow passing from the pulse generator 5, which may for example comprise a sample valve or an injector, will consist entirely of an inert carrier fluid. During an experiment, the pulse generator 5 will inject, e.g., one or more pulses of a probe into the carrier fluid flow. If a step function is to be generated, it is preferred to turn on the probe flow generator 4 for the duration of the step.

If the probe flow generator 4 is turned on permanently, in which case, e.g., a static mixer or a feed line with a small diameter for homogeneously mixing the carrier fluid and the probe is provided, or if the carrier flow generator is being fed with a carrier fluid that already contains a probe, the fluid flow passing the pulse generator 5 will consist entirely of a mixture of an inert carrier fluid and a probe. Thus, the catalyst sample contained in the reactor tube 2 is continuously being perfused with a probe, and experiments can be performed, e.g., by means of a temperature program imposed on the reactor tube 2 or by injecting one or more pulses or a step function of the (unmixed) carrier fluid into the carrier/probe mixture flow.

It is preferred that the flow module 1 is programmable at least in terms of flow and composition of the carrier/probe mixture. A suitable probe or carrier flow generator is, for instance, the Brooks 5850 S mass flow controller. The carrier fluid may be, for instance, an inert gas such as helium or nitrogen. The probe can be any chemical agent with which the sample of a solid material can be tested. If the said solid material is a catalyst, the probe can, e.g., consist of hydrogen, oxygen, hydrogen sulphide, organic compounds, with or without heteroatoms such as sulphur or nitrogen, or mixture thereof.

For a detailed description of pulse experiments, reference may be had to, e.g., Coopmans, J. F. “Kinetics of Vacuum Gas Oil Cracking on a Zyolitic Catalyst,” I&EC RESEARCH, 1992, page 31 ff.

The aforementioned feed line is connected to a reactor tube 2 placed in a holder. Upon insertion of a tube in the holder, a connection is established between the feed line and this tube. This connection is preferably such that the flow of a carrier fluid containing a probe is left substantially undisturbed by, e.g., accelerations or changes in pressure, temperature or surface conditions of the inner wall of the feed line or the reactor tube 2. Disturbing the carrier fluid and/or the probe is likely to result in loss of information obtainable from the experiments.

It is also possible to inject a probe and/or additional carrier fluid directly into the reactor, e.g., through one or more nozzles near the outlet of the feedline. Such a configuration is especially applicable to systems employing a gaseous carrier fluid flow and a liquid probe and/or liquid additional carrier fluid.

The reactor unit is preferably provided with an oven or a heater so as to control the temperature at which the sample of a solid material is in contact with the probe.

A catalyst sampler 6 or magazine is positioned near the holder for storing reactor tubes containing catalyst samples and for replacing the tubes in the holder via a conveyor. The catalyst sampler should preferably be able to contain a large number of samples, e.g., ten, thirty or fifty or more. Also, it is preferred that means are provided to condition the stored samples.

A suitable automated thermal desorption unit, that can be used instead of the holder and the catalyst sampler, is known for instance from U.S. Pat. No. 4,976,924, incorporated herein by reference thereto. This document describes a thermal desorption unit into which a magazine comprising mini-tubes can be stacked with the lowest mini-tube pushed into a tube holder via a conveyor and the remaining tubes moving to a lower position due to gravity. The mini-tubes contain samples taken from, e.g., a workplace environment in order to monitor air quality. Each mini-tube is selectively withdrawn automatically from the magazine, the sample absorbed in the tube taken from the mini-tube by heating, the mini-tube flushed with heated air to cleanse the absorption material within the mini-tube and the inner wall of the tube, and the tube then replaced within the magazine. U.S. Pat. No. 4,976,924 does not disclose or imply the addition of a probe to the heated air.

The output of the reactor tube 2 is connected to an analysis module 7 for determining (certain aspects of) the composition of the reaction products exiting the reactor tube, which module may, e.g., contain a gas chromatograph or chromatographic detectors like a thermal conductivity detector, flame ionization detectors or spectroscopic detectors like a mass spectrometer or an UVVIS spectrometer. Thus, the difference in composition at the inlet and the outlet of the reactor tube 2 can be established, preferably as a function of time.

### EXAMPLES

Pulse Testing:

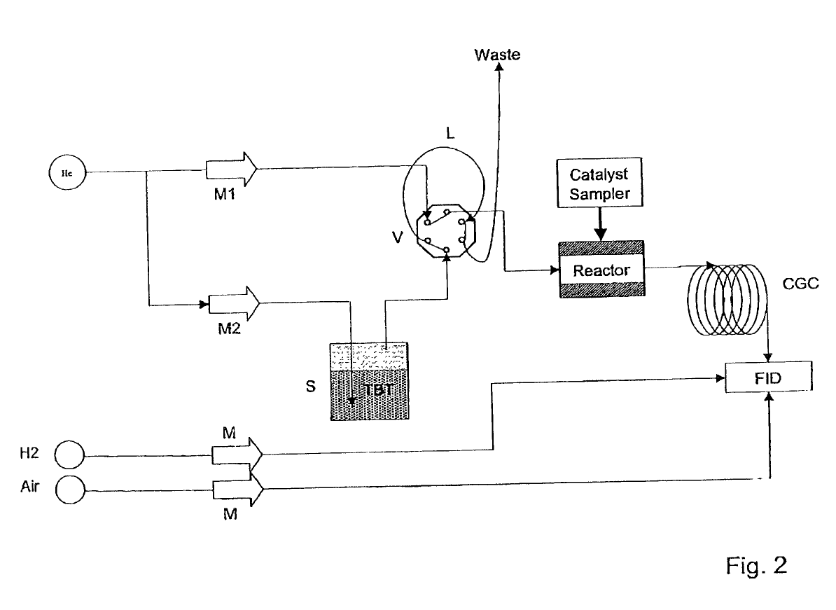

The activity of heterogeneous catalysis can be measured by pulse experiments (see e.g., R. J.Kokes, H.Tobin, P. H.Emmett, J.Am.Chem.Soc., 77, 5860-5862, 1955). The activity of a hydro processing catalyst was measured by the cracking of 4-tert.butyltoluene (TBT) into toluene and iso-butene. To this end, a configuration as shown in FIG. 2 was employed, wherein the flow module comprised a helium source He, two mass flow controllers M1 and M2, a TBT saturator, and a rotary valve V combined with a loop L which together served as a pulse generator. The analysis module comprised a capillary gas chromatographic column CGC, a flame ionization detector FID and feeds for hydrogen and air. The experiments were carried out by loading ten tubes filled with 20+/−0.5 mg of catalyst sample to be measured in the catalyst sampler and automatically placing one after the other in a tube holder where the tube (reactor) was heated to and kept at a temperature of 250° C. by means of an oven (not depicted).

The sample in the reactor was constantly flushed with helium at a constant flow rate of 20 ml/min. In the fill position (FIG. 2) of the rotary valve, the loop was constantly flushed with TBT saturated helium. A certain amount of gaseous TBT was injected in the flow path by rotating the rotary valve to the next position. The volume of the loop, i.e. 250 μl, and the temperature of the saturator filled with liquid TBT determined the amount of TBT injected.

The TBT was thus transported to the sample in the reactor, where the cracking took place. The products and the TBT that did not react were transported to the CGC, cryo-focussed and, afterwards, analyzed using temperature programming. The TBT conversion was determined from the areas of TBT, toluene and iso-butene as determined by the FID. The standard deviation of the TBT conversion of ten measurements was 3.4% at a conversion level of 73.2%.

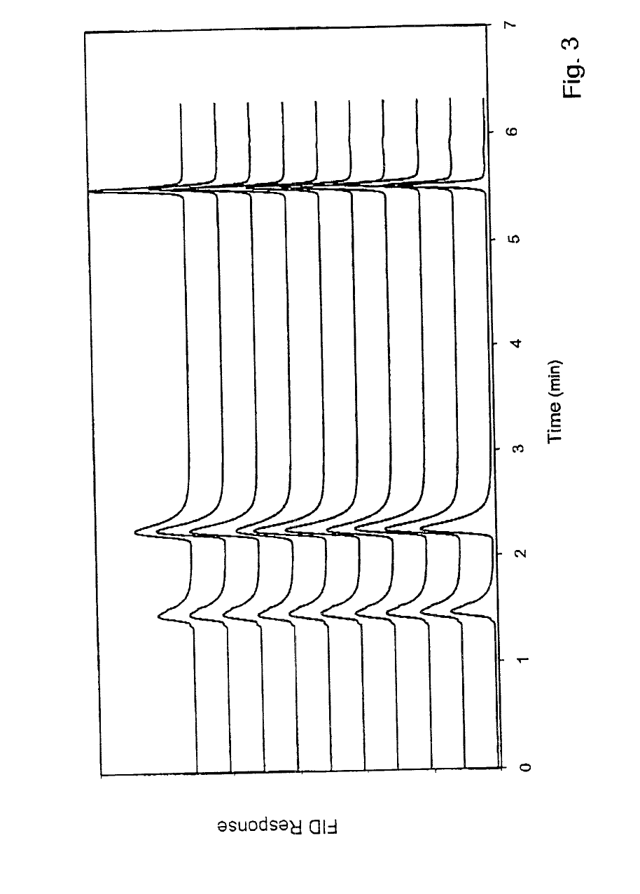

The same sample was analysed ten times, resulting in the chromatograms given in FIG. 3.

Temperature programmed reduction (TPR): TPR is a technique used for the chemical characterization of solids (see e.g. Temperature-Programmed Reduction for solid Materials Characterization, A.Jones, B.McNicol, Marcel Dekker, Inc, 1986). The essence of the technique is the reduction of a solid sample by a gas, e.g. hydrogen, whilst the temperature of the system is changed in a controlled and predetermined manner.

During the temperature programming, the amount of hydrogen consumed is measured. If the hydrogen consumption is plotted against the temperature, often a series of peaks are observed. Each peak represents a distinct reduction process involving a particular chemical component contained in the solid sample. The chemical nature and environment of the chemical component determine the apex of a peak, and the area of the peak reflects the concentration of that component present in the solid.

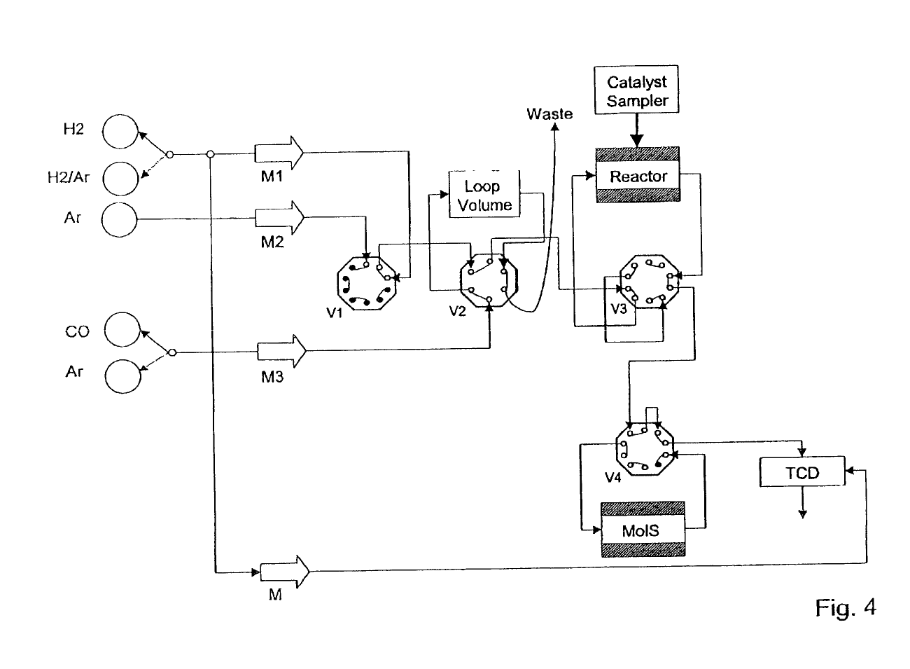

To carry out TPR, a configuration as shown in FIG. 4 was employed, wherein the flow module comprised a hydrogen source H2, a argon source Ar (or a single combined source H2/Ar) mass flow controllers M1 and M2 (respectively one mass flow controller M1), and a rotary valve V2. The analysis module comprised a thermal conductivity detector TCD and a molecular sieve MoIS for trapping any water formed during the reduction of the sample.

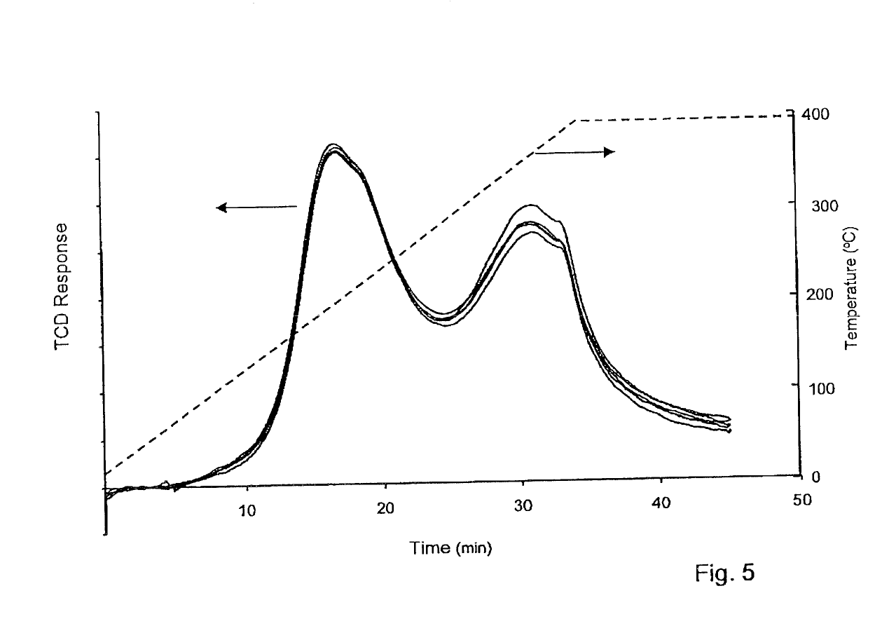

FIG. 5 gives the results of the temperature programmed reduction of a series of ultra-stable Y-zeolite loaded with 0.6% platinum calcined in air at 450° C. Shown is the TPR profile of five successive TPR runs of 100+/−0.5 mg of this sample using automatic catalyst exchange. The flow was in this case 20 ml/min of 23% hydrogen in argon. Hydrogen consumption was determined by means of the TCD.

Pulse Chemisorption:

The dispersion of metals on catalysts can be determined by quantifying the amount of carbon monoxide that chemisorbs on the active sites of the metal surface. Pulse chemisorption is a convenient, fast way to measure this characteristic by a dynamic flow method. The configuration as shown in FIG. 4 was employed, wherein the flow module comprises a carbon monoxide source CO, an argon source Ar, a mass flow controller M3, and a rotary valve V2 combined with a loop (Loop Volume) which together served as a pulse generator. The analysis module was the same as in the previous set of experiments.

The samples were kept at a certain temperature and subjected to a series of pulses of CO. The first pulses were chemisorbed by the sample until the maximum chemisorption capacity of the sample was reached. Subsequent pulses passed through the sample and were detected by the TCD.

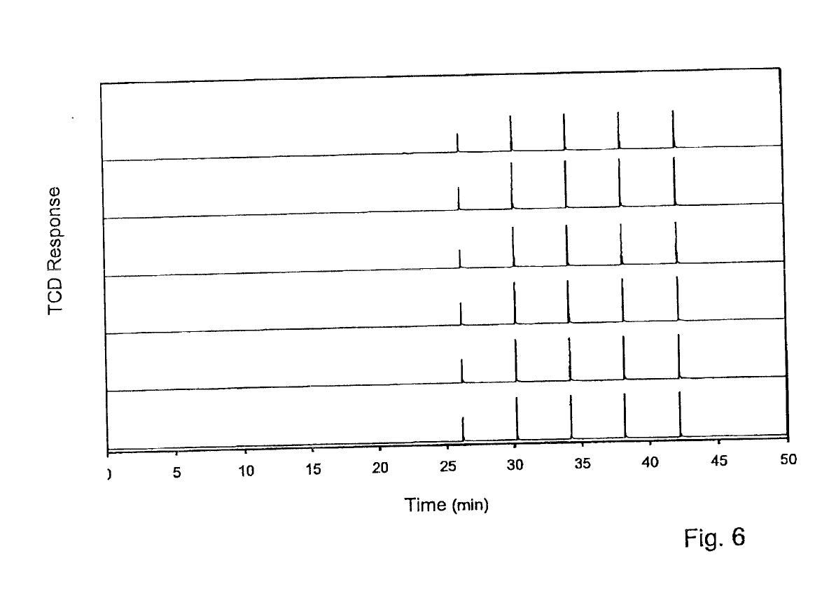

FIG. 6 shows the results of the CO-chemisorption of a series of six tubes filled with 100 mg +/−0.5 mg of porous alumina with 0.6% platinum calcined in air at 550° C., using automated catalyst sample exchange. The samples had to be reduced before the CO pulse chemisorption determination. This was performed at a flow of 20 ml/min hydrogen using the following temperature program: initial temperature 50° C., ramping at 10° C./min to 395° C., hold at final temperature for 15 minutes. After cooling down to room temperature, the sample was subjected to a series of 10 pulses of 8 μl CO (NTP). The average amount of chemisorbed CO was 45.9 μl and the standard deviation of the six measurements was 0.6 μl.

From the above examples, it is apparent that the invention enables high-throughput experimentation, in a very reproducible manner (FIGS. 3, 5 and 6) and by means of an apparatus using existing components.

The invention is not in any way restricted to the embodiments described above, which can be varied in a number of ways within the scope of the claims. For instance, within the framework of the present invention, the term “tube” encompasses any reactor that is capable of holding a sample of a solid material and that is preferably also suitable for insertion into a thermal desorption unit of some sort.

1. An apparatus for testing samples of a solid material contained in a reactor tube, said apparatus comprising a holder for said tube, a flow module for generating a carrier fluid flow containing a probe through said tube positioned in said holder, a magazine for additional tubes, and a conveyor for replacing said tube positioned in said holder with an additional tube from said magazine.

2. The apparatus of claim 1 wherein said solid material comprises a catalyst or an adsorbent.

3. The apparatus of claim 1 wherein said reactor tube, said holder for said tube, said magazine for additional tubes, and said conveyor for replacing said tube positioned in said holder with an additional tube from said magazine comprises an automated thermal desorption unit.

4. The apparatus of claim 1 wherein the flow module further comprises an injector for injecting a probe and/or additional carrier fluid into the carrier fluid flow.

5. The apparatus of claim 4 wherein the injector is positioned relatively close to the holder.

6. The apparatus of claim 1 wherein said flow module comprises a feedline for establishing fluid communication with a tube that is placed into the holder and wherein the cross-sectional area of the lumen of the feed line is substantially smaller than the cross-sectional area o f the lumen of the tube.

7. The apparatus of claim 1 wherein means are provided for accurately controlling the temperature of said tube in said holder.

8. The apparatus of claim 1 which further comprises an analysis module for at least partially determining the composition of the reaction products exiting said reactor tube.

9. A method of testing a plurality of samples of a solid material contained in a reactor tube by means of an apparatus comprising a holder for a tube, a flow module for generating a carrier fluid flow containing a probe and a magazine for additional tubes, which method comprises placing said tube in said holder, generating a carrier fluid flow through said tube, and replacing said tube with an additional tube from said magazine.

10. The method of claim 9 wherein said probe and/or additional carrier fluid is injected into the carrier fluid flow relatively close to said holder.

11. The method of claim 9 wherein said reactor tube, said holder, and said magazine comprises an automated thermal desorption unit.
